(19) United States
(12) Patent Application Publication
(10) Pub. No.: US 2021/0195871 A1
(43) Pub. Date: Jul. 1, 2021

(54) Fishbowl Toy for Pet

(71) Applicant: Leshwo Rocity (Shenzhen) Industrial Co., Ltd., Shenzhen (CN)

(72) Inventor: Weijun XIAO, Shenzhen (CN)

(21) Appl. No.: 17/001,693

(22) Filed: Aug. 25, 2020

(30) Foreign Application Priority Data
Dec. 30, 2019 (CN) 2019224301653

(51) Int. Cl. A01K 15/02

(52) U.S. Cl. CPC A01K 15/025

(57) ABSTRACT

A fishbowl toy for pet includes a base, a transparent surrounding wall cover, a driving unit, and a turntable for one or more playthings, such as table tennis ball, golf ball, little doll, stuffed toy mouse, fluffy ball, and etc., to be placed on the turntable, so as to allow the turntable to bring the playthings to rotate like dynamic objects that attract a pet to catch them. The transparent surrounding wall cover has an open end communicating with outside that enable the pet to grasp the playthings therethrough, wherein when the pet caught a plaything, it will feel rewarded and like to play with the fishbowl toy. Accordingly, the feature of the fishbowl toy is adapted to actively attract the interest and attention of the pet and leads the pet to play with the fishbowl toy, rather than to scratch and damage the household settings.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to the field of pet toy, and more particularly to a fishbowl toy for pet.

### Description of Related Arts

Cats love to play. Their frequent scratches and claw honing often somehow damage household settings, such as couches, carpet, curtains, and etc. To address this issue, there are scratching board specifically for cats to hone their claws. Unfortunately, even though this kind of product is able to solve the claw honing problem itself, it only serves this specific purpose. In addition, cats like to watch fishbowl as well as to catch fish with their claw. It is their nature. Conventionally, power-driven toy fish is placed in water. When a cat catches the fish, it will wet its claw, which not only renders a risk of nail inflammation without timely and close attention, but also causes wet floor or gets the carpet, couch, sofa, or etc. wet by the cat with its wet claws. Hence, there is an urgent need of an innovative fishbowl toy for pet for addressing the problem of the prior art. Accordingly, a novel concept and technical solution is provided in the present invention.

### SUMMARY OF THE PRESENT INVENTION

An object of the present invention is to provide a fishbowl toy for pet in order for overcoming the above drawback issues as well as achieving advantages as described in the present invention.

In order to achieve the above and other objects, the present invention provides a fishbowl toy for pet, including a base, a transparent surrounding wall cover having an enclosing chamber therein, an open end and an affixing end mounted on the base such that an upper surface of the base and the enclosing chamber of the surrounding wall cover form and define a hollow cavity, a turntable which is arranged in the hollow cavity and configured for allowing at least a plaything to place thereon, and a driving unit arranged on the base and rotatably coupled with the turntables for driving unit the turntable to rotate.

Preferably, the plaything may be, but not limited to, table tennis ball, golf ball, little doll, stuffed toy mouse, fluffy ball, and etc.

Preferably, the fishbowl toy for pet includes one or more playthings.

Preferably, the fishbowl toy for pet also includes a yarn element, wherein an end of the yarn element is detachably affixed on the turntable.

Preferably, the fishbowl toy for pet also includes a yarn element which two ends are affixed on the turntable.

In comparison with the conventional art, advantages of the present invention include the following. The cavity defined by the transparent surrounding wall cover and the upper surface of the base is made and shaped like a fishbowl that a pet (e.g. a cat and etc.) would like and probably has experience playing with. The transparent surrounding wall cover of the fishbowl-like structure also allows the pet to see through and note that there is object(s) (i.e. plaything(s), yarn(s), and etc.) moving inside of the fishbowl-like structure, so as for drawing the pet's attention and arousing its curiosity for looking closer as well as grasping the object(s) therefrom. Specifically, the utilization of the driving unit to turn the turntable and the playthings (e.g. table tennis ball, golf ball, little doll, stuffed toy mouse, fluffy ball, and etc.) provided on the turntable allow the turntable to bring the playthings to rotate and create dynamic objects that attract the pet to catch them. In which, the opening provided at the open end of the transparent surrounding wall cover allows the pet to grasp the plaything(s) in the hollow cavity, so that when the pet catches a plaything, the pet will feel rewarded and be encouraged to like to play with the toy more. Accordingly, in comparison with the conventional situation without taking any measure, the features of the fishbowl toy for pet of the present invention actively attract the interest and attention of the pet, and the pet that likes to play is more likely to be attracted to play with the fishbowl toy rather than to frequently scratch and damage the household settings with its claws.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is an exploded perspective view of a fishbowl toy for pet according to a preferred embodiment of the present invention.

FIG. 2 is an exploded sectional view of the fishbowl toy for pet according to the above preferred embodiment of the present invention.

FIG. 3 is a partial sectional view of the fishbowl toy for pet according to the above preferred embodiment of the present invention.

### DETAILED DESCRIPTION OF THE PREFERRED EMBODIMENT

A preferred embodiment of the present invention will be clearly and fully disclosed as follows along with the drawings of the present invention. Obviously, the disclosed embodiment is only one of the practical embodiments illustrating the technical solution of the present invention, that a person skilled in the art can obtain equivalent modes and other embodiments based on the disclosed embodiment of the present invention and without creative work, and these apparent alternative modes should be covered by scope of the instant invention.

Person skilled in the art should be able to understand that the technical solution of the present invention being disclosed to such extent shall be completely sufficient for him/her to implement and address the issues mentioned in the background. Hence, if a person skilled in the art faces a new technical when s/he embodies the present technical solution, it may be a new issue for continuous development based on the present invention, rather than evidence indicating that the present invention fails to be fully disclosed or implemented. If any part of an embodiment disclosed in the present invention cites prior art without specific or detail description, person skill in the art may naturally consider such details as prior art.

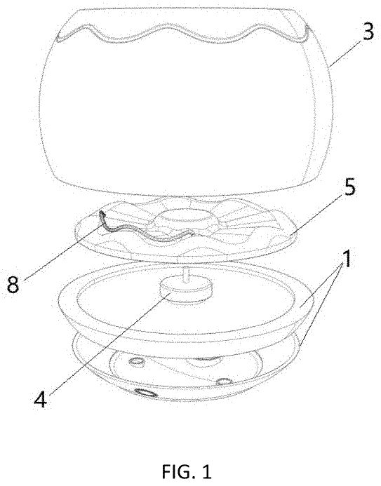

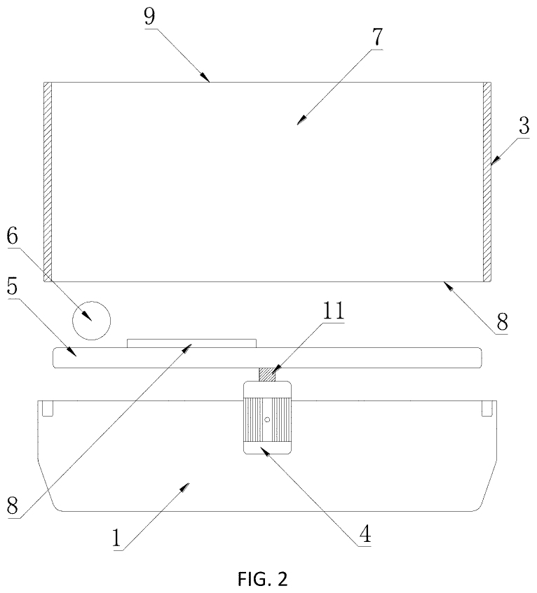

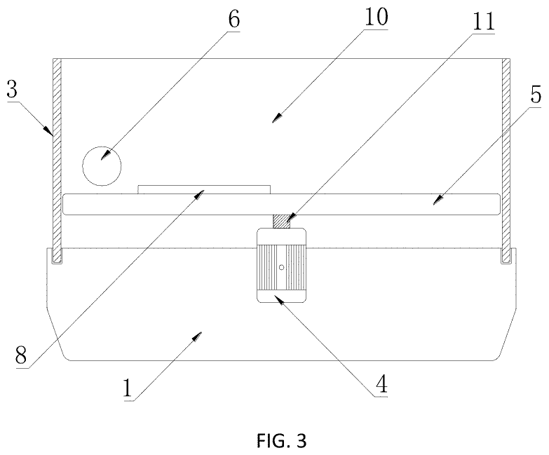

Referring to FIGS. 1-3, the present invention relates to a technical solution regarding pet toy and provides a fishbowl toy for pet, which comprises a base 1, a transparent surrounding wall cover 3, a driving unit 4, and a turntable 5 for one or more playthings 6. The transparent surrounding wall cover 3 has an open end 8, an affixing end 9 and an enclosing chamber 7 therein extending between the open end 8 and the affixing end 9 which is configured to mount on an upper surface of the base 1, such that the enclosing chamber 7 forms a hollow cavity 10 defined by the surrounding wall cover and the base 1. The transparent surrounding wall cover 3 is preferred to be made of transparent plastic material, transparent glass material, or other similar transparent materials and have a fishbowl shape. After the transparent surrounding wall cover 3 is combined with the base 1 by mounting the affixing end of the surrounding wall cover 3 on the upper surface of the base 1, the affixing end of the surrounding wall cover 3 is covered by base 1 and the enclosing chamber 7 within the surrounding wall cover 3 forms the hollow cavity 10 for receiving the one or more playthings 10 therein. The driving unit 4, such as a motor, is mounted in the base 1. The turntable 5 is disposed in the cavity 10 and is rotatably coupled with the driving unit 4, so as to allow the driving unit 4 to rotate the turntable 5 which is configured for placing the one or more playthings 10 thereon in the cavity 10.

According to a preferred embodiment of the present invention, the driving unit 4 comprises rotation axle 11 connected with the turntable 5 so that the rotating of the rotation axle 11 is able to drive the turntable 5 to rotate about the rotation axle 11 while the one or more playthings 6 are placed on a top surface of the turntable 5.

Preferably, the one or more playthings 6 can be, but not limited to, table tennis ball, golf ball, little doll, stuffed toy mouse, fluffy ball, and etc. The fishbowl toy for pet may further comprises an elongated element, such as a yarn, 8. A side of the yarn 8 may be detachably affixed on the top surface of the turntable 5 through adhesive, loop and hook fasteners, or other means. Both ends of the yarn 8 may also be securely affixed and attached on the top surface of the turntable 5 in the hollow cavity 10. Through the yarn 8, which is affixed on the turntable 5 to prevent from being caught by the cat, the yarn seems moving when it is rotated with the turntable 5 that would attract the cat's attention. In other words, because a side and one or both ends of the yarn 8 are affixed on the turntable 5, it can barely be removed by the cat, such that the user does not have to constantly find and replace the yarn 8. Nevertheless, according to the preferred embodiment, the yarn 8 is detachably affixed on the top surface of the turntable 5, which allows the user to restore or replace the yarn 8 easily when needed. According to some other embodiments, the yarn 8 may merely have its one end being attached on the top surface, such that the yarn 8 would move more vividly to attract the pet.

Person skilled in the art should be able to understand that this embodiment of the present invention is just a preferred implementation, wherein the current industrial production may inevitably have some errors and tolerances in various perspectives. Person skilled in the art may also easily and flexibly decide specific implementations and specifications based on the disclosure of the preferred embodiment of the present invention which should also be considered as within the scope of the present invention.

In view of the above description, advantages of the present invention include the following. The driving unit 4 is arranged to drive the turntable 5 to turn or rotate and one or more playthings 6 (such as table tennis ball, golf ball, little doll, stuffed toy mouse, fluffy ball, and etc.) can be placed or disposed on the turntable 5, so that the one or more playthings 6 will be brought by the turntable 5 to rotate with the turntable 5 like dynamic objects that would attract the pet to catch them. Since the upper end 9 of the transparent surrounding wall cover 3 is configured open as the open end for allowing the pet to grasp the one or more playthings 6 therethrough, the pet will feel rewarded and encouraged when it catches a plaything 6 it likes from the turntable 5 through the open end 9. Accordingly, not only the fishbowl shape of the fishbowl toy of the present invention can utilize tactively attract the interest and attention of the pet, the pet would feel interesting and be rewarded from getting the plaything 6 it likes from the fishbowl toy, that substantially leads and encourages the pet to play with the fishbowl toy of the present invention, rather than passively wait the naughty pet to play a static scratching board. As a result, the pet is less likely to scratch and damage the household settings.

According to the preferred embodiment of the present invention, the driving unit 4 is embodied as a motor with power supply and/or relative control circuit incorporated therewith, wherein the type and size of the motor 4 are determined and arranged corresponding to the type and size of the other elements and components of the present invention, including the base 1, the transparent surrounding wall cover 3, the turntable 5, as well as the one or more playthings 6. More specifically, the motor 4 is affixed on the base 1. The transparent surrounding wall cover 3 has the enclosing chamber 7 defined therein and extended between the lower affixing end 8 and the upper open end 9, wherein the affixing end 8 of the transparent surrounding wall cover 3 is securely affixed on the upper surface of the base 1 such that the enclosing chamber 7 of the surrounding wall cover 3 is closed at the affixing end 8 by the base 1 to define the hollow cavity 10 of the fishbowl toy by the surrounding wall cover 3 and the base 1 thereof while the open end 9 communicating with outside and the turntable 5 which is affixed to the rotation axle 11 of the motor 4 is disposed in the hollow cavity 11. In other words, within the cavity 10, the driving unit 4 is mounted above or on the upper surface of the base 1. The turntable 5 which has a size at least slightly smaller than the size of the cavity 10 is connected with the rotation axle 11 of the driving unit 4, wherein the rotation axle 11 is preferrably connected to a center of a lower surface of the turntable 5 so that the turntable 5 is rotated about the rotation axle 11 within the cavity 10 by the motor 4. The turntable 5 has a top surface and the one or more playthings 6 (such as table tennis ball, golf ball, little doll, stuffed toy mouse, fluffy ball, and etc.) are placed on the top surface of the turntable 5, such that the one or more playthings 6 are moved with the rotating turntable 5 that seems like dynamic objects to attract the pet to catch them. Since the upper open end 9 of the transparent surrounding wall cover is opened to outside, the pet is capable of grasping the playthings 6 through the open end 9, wherein when the pet catches a plaything 6, it will feel rewarded and be encouraged to participate such activity that not only prevents the pet to scratch and damage the actual household objects and settings, but also provides a good exercise for the pet. Therefore, the present invention can utilize the feature of fishbowl shaped of the surrounding wall cover 3 to actively attract the interest and attention of the pet and lead the pet to play with the fishbowl toy, rather than letting the pet to scratch and damage the household objects and settings or passively wait the pet to use a static scratching board. As a result, the pet is less likely to scratch and damage the household settings due to its nature of playing.

It is appreciated that a power supply may additionally be connected to the driving unit 4 so as to allow the driving unit to rotate the turntable 5. The rotational speed of the driving unit 4 should be considered and embodied in a moderate speed, usually 30-50 rpm, which should be within an expandable implementation for person skilled in the art. The fastening means implemented in the preferred embodiment, such as the mounting of the surrounding wall cover 3 and the base 1 and the turntable 5 with the driving unit 4, can be any rigid and durable means known in the art, which shall also be considered as within the scope of the present invention. In other words, based on the disclosed preferred embodiment of the present invention, person skilled in the art may utilize his/her logic analysis and reasoning to make up the unspecified details of the present invention, so as to alter or modify the implementation of the present invention. Besides, person skilled in the art may also continuously working on the inventive concept of the present application and submit other patent application that achieves an optimized result in the present field of technology.

It shall be noted for the present implementation that conventional control circuit for controlling the actions of the elements as well as the corresponding controlling programs and procedures, if any, may apply in the present invention. The drawings of the present invention are only for assisting person skilled in the art to understand the principles of the present invention. Due to the restrictions of the page size of a patent application and in order to clearly illustrate the principle of the present invention, the relative sizes among parts in the drawings may vary from the actual product, which person skilled in the art may understand. For example, in order to emphasize certain part of the structure and principle in the figures, the part may be drawn larger, which can consequently render some other parts seem too small, which shall be understandable under this condition. Hence, person skilled in the art should be able to understand that, based on the principles of the present invention, more industrialized and reasonable designs may also be applied and utilized to make parts of the present invention smaller and finer and more practical.

It should be understood that, in the descriptions of the present invention, terminologies that instructs directional or positional relations, such as “coaxial”, “bottom”, “an end”, “top”, “middle”, “the other end”, “upper”, “a side”, “upper portion”, “inner”, “front portion”, “center”, “two ends”, and etc., refer to the directional or positional relations based on the drawings and are only for ease of describing the present invention in a simplified manner, rather than indication of suggestion of any required specific directions and/or required specific structure/operation of direction. Therefore, they shall not be considered as limitations to the present invention. Person skilled in the art should understand that the functions and advantages of the present invention are advantageous than conventional technology only in a specific circumstance, rather than the best in the industry in an overall manner.

According to the present invention, unless otherwise specifically defined or limited, terminologies “mount”, “arrange”, “connect”, “affix”, “pivotally couple”, and so on shall be interpreted in a wide manner. For example, an element could be securely connected, dismantably connected, integrally connected, mechanically connected, electrically connected, directly connected, connected through some intermediate element, connected in an internally communicated manner, connected through some interaction, and etc. Unless otherwise specifically defined, person skilled in the art should be able to understand the specific meanings of these terminologies in the present invention based on specific and actual conditions.

Although certain embodiment(s) of the present invention have been illustrated and disclosed, person skilled in the art is able to note various changes, modifications, substitutions, and alternatives to the embodiment(s) within the spirit and scope of the present invention. Hence, the present invention shall be protected based on the scope defined by the appended claims and the equivalents thereof.

What is claimed is:

1. A fishbowl toy for pet, comprising:
a base;
a transparent surrounding wall cover, having a fishbowl shape, mounted on said base in such a manner that a hollow cavity is formed and defined between said base and said transparent surrounding wall cover with an open end communicating outside;
a driving unit, mounted in said base; and
a turntable, arranged in said cavity and rotatably coupled with said driving unit so as for allowing said driving unit to rotate said turntable, thereby one or more playthings are capable of being placed on said turntable to be moved with a rotation of said turntable.

2. The fishbowl toy for pet, as recited in claim 1, further comprising a yarn having at least a portion detachably affixed on said turntable.

3. The fishbowl toy for pet, as recited in claim 1, further comprising a yarn having a side affixed on said turntable.

4. The fishbowl toy for pet, as recited in claim 1, further comprising a yarn having at least one end detachably affixed on said turntable.

5. The fishbowl toy for pet, as recited in claim 1, wherein said one or more playthings adapted for placing on said turntable is selected from the group consisting of table tennis ball, golf ball, little doll, stuffed toy mouse, fluffy ball, and combinations thereof.

6. The fishbowl toy for pet, as recited in claim 2, wherein said one or more playthings adapted for placing on said turntable is selected from the group consisting of table tennis ball, golf ball, little doll, stuffed toy mouse, fluffy ball, and combinations thereof.

7. The fishbowl toy for pet, as recited in claim 3, wherein said one or more playthings adapted for placing on said turntable is selected from the group consisting of table tennis ball, golf ball, little doll, stuffed toy mouse, fluffy ball, and combinations thereof.

8. The fishbowl toy for pet, as recited in claim 4, wherein said one or more playthings adapted for placing on said turntable is selected from the group consisting of table tennis ball, golf ball, little doll, stuffed toy mouse, fluffy ball, and combinations thereof.

9. The fishbowl toy for pet, as recited in claim 1, wherein said transparent surrounding wall cover has an affixing end mounted on said base to define said hollow cavity while said turntable is rotatably disposed above said base and within said hollow cavity.

10. The fishbowl toy for pet, as recited in claim 2, wherein said transparent surrounding wall cover has an affixing end mounted on said base to define said hollow cavity while said turntable is rotatably disposed above said base and within said hollow cavity.

11. The fishbowl toy for pet, as recited in claim 3, wherein said transparent surrounding wall cover has an affixing end mounted on said base to define said hollow cavity while said turntable is rotatably disposed above said base and within said hollow cavity.

12. The fishbowl toy for pet, as recited in claim 4, wherein said transparent surrounding wall cover has an affixing end mounted on said base to define said hollow cavity while said turntable is rotatably disposed above said base and within said hollow cavity.

13. The fishbowl toy for pet, as recited in claim 1, wherein said driving unit is a motor and said turntable is affixed to a rotation axle of said motor for being driven to rotate about said rotation axle.

14. The fishbowl toy for pet, as recited in claim 2, wherein said driving unit is a motor and said turntable is affixed to a rotation axle of said motor for being driven to rotate about said rotation axle.

15. The fishbowl toy for pet, as recited in claim 3, wherein said driving unit is a motor and said turntable is affixed to a rotation axle of said motor for being driven to rotate about said rotation axle.

16. The fishbowl toy for pet, as recited in claim 4, wherein said driving unit is a motor and said turntable is affixed to a rotation axle of said motor for being driven to rotate about said rotation axle.

17. The fishbowl toy for pet, as recited in claim 9, wherein said driving unit is a motor and said turntable is affixed to a rotation axle of said motor for being driven to rotate about said rotation axle.

18. The fishbowl toy for pet, as recited in claim 10, wherein said driving unit is a motor and said turntable is affixed to a rotation axle of said motor for being driven to rotate about said rotation axle.

19. The fishbowl toy for pet, as recited in claim 11, wherein said driving unit is a motor and said turntable is affixed to a rotation axle of said motor for being driven to rotate about said rotation axle.

20. The fishbowl toy for pet, as recited in claim 12, wherein said driving unit is a motor and said turntable is affixed to a rotation axle of said motor for being driven to rotate about said rotation axle.
